(19) United States
(12) Patent Application Publication
(10) Pub. No.: US 2007/0226731 A1
(43) Pub. Date: Sep. 27, 2007

(54) MODULARITY

(76) Inventors: Ariel D. Tseitlin, Sunnyvale, CA (US); Daniel Kearns, Moss Beach, CA (US)

Correspondence Address: CAMPBELL STEPHENSON LLP, 11401 CENTURY OAKS TERRACE, BLDG. H, SUITE 250, AUSTIN, TX, 78758, US

(21) Appl. No.: 11/426,269

(22) Filed: Jun. 23, 2006

Related U.S. Application Data
(60) Provisional application No. 60/693,589, filed on Nov. 16, 2005.

(51) Int. Cl. G06F 9/44

(52) U.S. Cl. 717/171

(57) ABSTRACT

A method is provided. The method determines a plurality of platforms on which a first enterprise module is intended to run. Further, the method determines a first set of code included in the first enterprise module that is compatible with at least one of the platform and is incompatible with at least one of the other platforms. The first set of code prepared to accomplish a task. In addition, the method establishes a dependency relationship with a second enterprise module to obtain a second set of code that is compatible with the platform that first set of code is incompatible with, the second set of code prepared to accomplish the task.

### RELATED APPLICATION

This application claims the benefit of and priority to U.S. Provisional Application Ser. No. 60/693,589, filed Jun. 24, 2005, the contents of which are incorporated by reference herein in its entirety.

### BACKGROUND

1. Field

A method and system are disclosed which generally relate to computer application environments.

2. General Background

Computer systems form the backbone of modern business. Computer systems are used in virtually every step of a business chain. For example, computer systems are used to purchase source materials, track production, monitor inventory levels, monitor quality, set pricing, maintain customer relationships, provide accounting services, maintain a payroll, provide employee benefits, track inbound/outbound shipments, track customer satisfaction or complaints, and perform countless other tasks to run a business.

A number of enterprise software applications have been created to allow a business to perform many of these business support functions with a single integrated software application. These enterprise software applications have provided the businesses that employ these applications with a competitive advantage. However, such enterprise software applications tend to be expansive applications that require significant computer resources to run and knowledgeable technicians to maintain. Furthermore, enterprise software applications tend to be expensive programs to purchase or lease. Thus, enterprise software applications have mainly been used only by very large corporations that are able to afford such infrastructure investments and continue to pay for their continued use.

Even very large corporations can have some difficulties with large enterprise software applications. For example, a large corporation may already have a legacy software application that the large corporation wishes to continue using. Thus, integrating the legacy software application with a new enterprise software application can be difficult and require very skilled application integrators.

Furthermore, corporations in different business segments often have very different needs from their enterprise software applications. Therefore, a corporation using with a “one-size-fits-all” enterprise software application may find that the “one-size-fits-all” enterprise software includes many unnecessary features. These unnecessary features needlessly cost the corporation money and consume valuable computer resources. The enterprise software application may also be missing a number of desired industry-specific features for each different corporation. These corporations must develop these missing features internally or find another software application that provides the needed features. If an additional software application that provides the missing features is located, then the corporation must integrate that additional application with the enterprise software application.

Due to these difficulties with large enterprise software applications, it would be desirable to fine a way to make such enterprise software applications more flexible. Specifically, it would be desirable to allow small businesses to be able to afford some of the features provided by enterprise software applications. Similarly, it would be desirable to allow large corporations to easily select and install only the needed features. And finally, it would be desirable to have an ability to easily integrate the enterprise software application with other customized applications.

### SUMMARY

In one aspect of the disclosure, a system is provided. The system has a unit that generates a first set of code for a first enterprise module. The first set of code is designed to run on a first platform. Further, the system has a unit that composes a portability tree for the first enterprise module. The portability tree includes a plurality of levels. In addition, the plurality of levels includes a root level, a first sub-level, and a second sub-level. The root level includes a portable platform. Further, the first sub-level includes a plurality of first sub-level non-portable platforms. In addition, the second sub-level including a plurality of second sub-level non-portable platforms. The system also has a unit that determines whether the first platform is present in the portability tree and what level of the portability tree the first set of code resides in. In addition, the system has a unit that establishes a dependency relationship with a second enterprise module, distinct from the first enterprise module, if the platform resides in the first sub-level or the second sub-level.

In another aspect of the disclosure, a machine readable medium has stored thereon a set of instructions which when executed perform a method. The method generates a first set of code and a second set of code for a first enterprise module. The first set of code is supported by a first platform. In addition, the second set of code is supported by a second platform. Further, the first set of code is distinct from the second set of code. In addition, the first platform is distinct from the second platform. In addition, the method composes a portability tree for the first enterprise module. The portability tree includes a plurality of levels. The plurality of levels includes a root level, a first sub-level, and a second sub-level. The root level includes a portable platform. Further, the first sub-level includes a plurality of first sub-level non-portable platforms. In addition, the second sub-level includes a plurality of second sub-level non-portable platforms. The method also determines whether the platform that the first set of code is designed to run on is present in the portability tree and what level of the portability tree the first set of code resides in. Further, the method determines whether the platform that the second set of code is designed to run on is present in the portability tree and what level of the portability tree the second set of code resides in. In addition, the method establishes a dependency relationship with a second enterprise module, distinct from the first enterprise module, if the platform that the first set of code is designed to run on resides in the first sub-level or the second sub-level. Finally, the method establishes a dependency relationship with a third enterprise module, distinct from the first enterprise module and the second enterprise module, if the platform that the second set of code is designed to run on resides in the first sub-level or the second sub-level.

In yet another aspect of the disclosure, a method is provided. The method determines a plurality of platforms on which a first enterprise module is intended to run. Further, the method determines a first set of code included in the first enterprise module that is compatible with at least one of the platforms and is incompatible with at least one of the other platforms. The first set of code prepared to accomplish a task. In addition, the method establishes a dependency relationship with a second enterprise module to obtain a second set of code that is compatible with the platform that first set of code is incompatible with, the second set of code prepared to accomplish the task.

### BRIEF DESCRIPTION OF DRAWINGS

The above-mentioned features and objects of the present disclosure will become more apparent with reference to the following description taken in conjunction with the accompanying drawings wherein like reference numerals denote like elements and in which:

FIG. 1 illustrates infrastructure utilized in a large and complex application, such as an enterprise application.

FIG. 2 illustrates an on-line or hosted infrastructure that can be utilized to provide an enterprise application over the Internet.

FIG. 3 illustrates an enterprise module assembly system that allows a customer to both host the enterprise application software locally and only purchase the particular modules corresponding to the services that the customer actually needs.

FIG. 4 illustrates a process of enhancing a computer system.

FIG. 5 illustrates an expanded view of the customer site, as seen in FIG. 3, for which the customer can implement the selected enterprise modules.

FIG. 6 illustrates an enterprise module construction system.

FIG. 7 illustrates a process in which the enterprise module can be generated.

FIG. 8 illustrates enterprise module dependencies.

FIG. 9 illustrates a portability tree that can be utilized to assess the portability of the code in the library collection of the enterprise module A.

FIG. 10 illustrates a process for creating a portable enterprise module.

FIG. 11 illustrates a process of generating a portable enterprise module.

### DETAILED DESCRIPTION

A method and apparatus for implementing a portable and open standards-based business application platform are disclosed. In the following description, for purposes of explanation, specific nomenclature is set forth to provide a thorough understanding of the present disclosure. However, it will be apparent to one skilled in the art that these specific details are not required in order to practice the method and apparatus disclosed herein. For example, although reference is made to the J2EE and .Net application platforms, the same techniques can easily be applied to other types of application platforms.

Certain computer application tasks require very large and complex computer software applications. For example, running an entire business operation requires a very large application (an “enterprise application”) that can handle many different tasks. Providing such large and complex enterprise software applications to a customer can be a great challenge to the enterprise software application developer.

Monolithic Application Executing at Customer Site

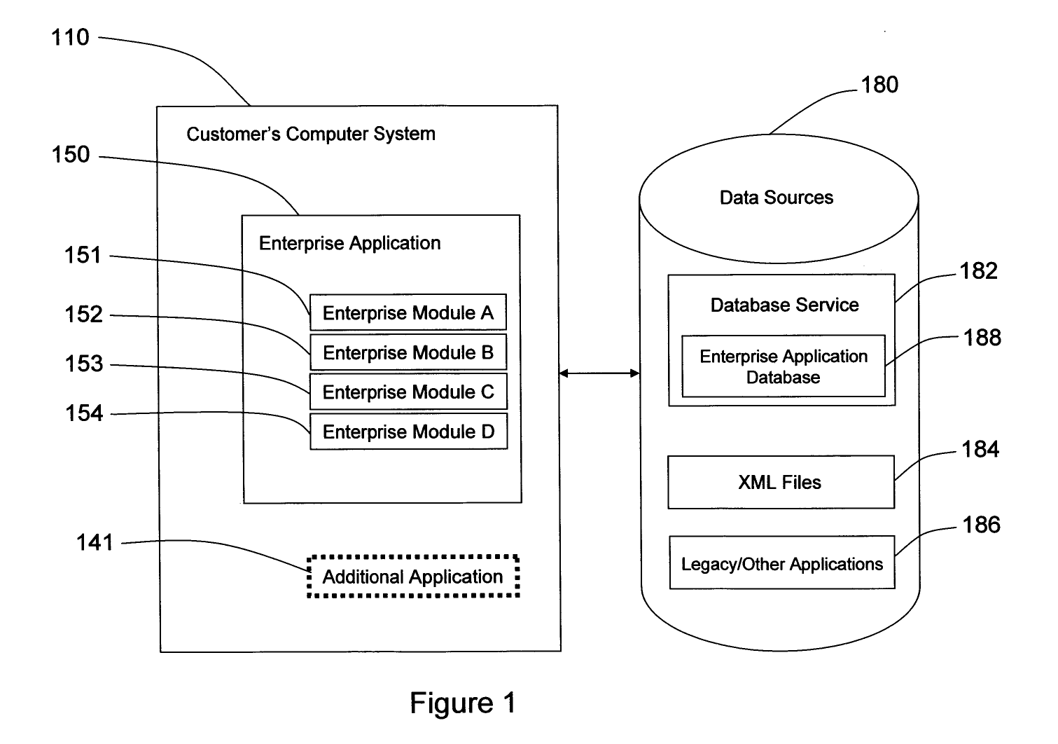

FIG. 1 illustrates infrastructure utilized in a large and complex application, such as an enterprise application. The infrastructure can be provided to the client by installing the enterprise application onto computers owned by the customer at the customer's premises. For instance, an enterprise application 150 can be installed to run on a customer's computer system 110. The enterprise application 150 may use data and/or services from the data sources 180, which include a database service 182, XML files 184, and legacy/other applications 186. Further, the database service 182 stores an enterprise application database 188.

The enterprise application 150 can be an expensive application, to purchase or lease, which utilizes significant computer resources. Further, installing and maintaining the enterprise software application 150 may require knowledgeable technicians. Thus, a smaller business might not want to use the large and complex enterprise application 150.

Even large corporations with significant computer resources and budgets may have difficulties with the large enterprise application. For example, a large corporation may already have a legacy software application that the corporation wishes to continue using. Thus, integrating the legacy software application with a new enterprise application 150 can be difficult and require very skilled application integrators.

The enterprise module 150 can include a variety of components, which form the building blocks of the enterprise module 150. An example of a component is a module, which is a collection of computer code that can be written to provide a service.

The enterprise application 150 may consist of many different individual modules. For example, as illustrated in FIG. 1, the enterprise module 150 can be composed of four individual enterprise modules: enterprise module A 151, enterprise module B 152, enterprise module C 153, and enterprise module D 154. A customer may need some of the enterprise modules while not needing others. For instance, a corporation may have use for the enterprise module A 151 and the enterprise module B 152, but may have no use for the enterprise module C and the enterprise module D. Further, the corporation may need an additional module that is not provided in the enterprise application 150. In those situations, the customer develops internally or purchases an additional application 141 that provides the features of the additional module. If an additional application 141 that provides the missing features is located, then the corporation must integrate that additional application 141 with the enterprise application 150. FIG. 1 illustrates the additional application 141 being integrated with the enterprise application 150. Such development is expensive because technical skills are needed to locate or develop the additional application 141 and then integrate the additional application 141 with the enterprise application 150. Accordingly, the corporation may not find the “one-size-fits-all” enterprise application 150 to be an optimal solution for its needs.

On-Line or Hosted Application Services

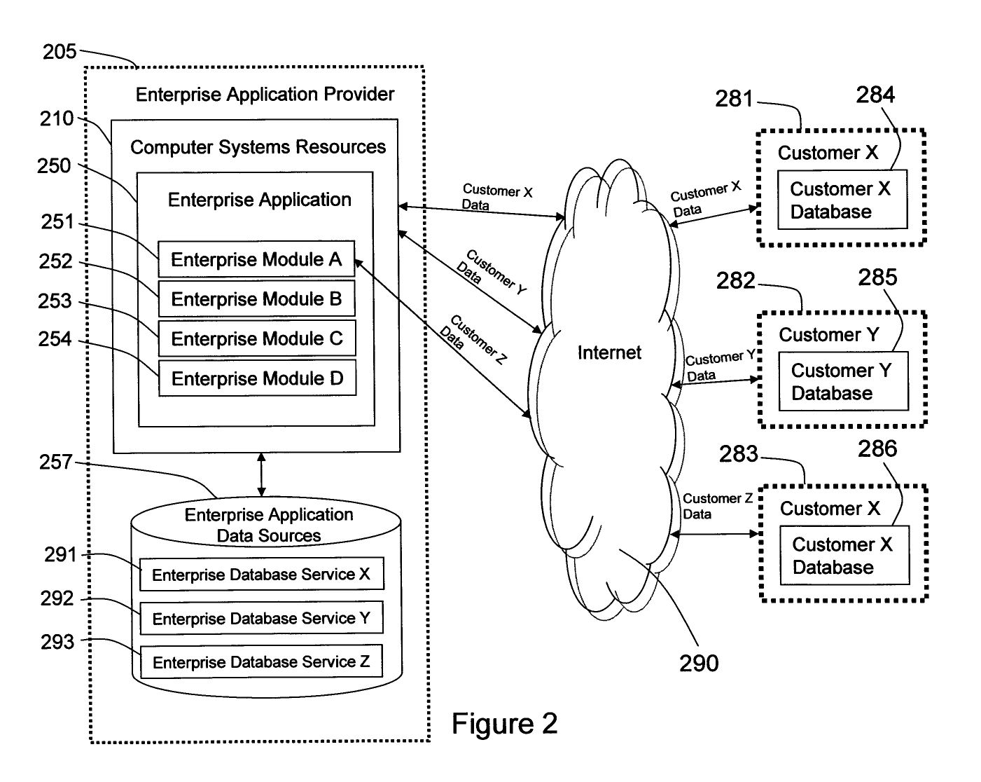

As an alternative to the monolithic enterprise software applications discussed above, enterprise application services can be provided to customers over the Internet. FIG. 2 illustrates an on-line or hosted infrastructure that can be utilized to provide an enterprise application 250 over the Internet 290. Specifically, an enterprise application provider 205 hosts the enterprise application 250 on a server and allows customers to access the server on-line. The server can be located at the enterprise application provider's facility. The enterprise application 250 mainly uses computer system resources 210 provided by the enterprise application provider 205. Customers such as customer X 281, customer Y 282, and customer Z 283 can access the enterprise application 250 over the Internet 290. Each of the customers can have a database. For instance, the customer X 281 may have a customer X database 284, the customer Y 282 may have a customer Y database 285, and the customer Z 283 may have a customer Z database 286. The enterprise application provider 205 keeps track of the different customer data using different database services in the enterprise application data sources 257, such as enterprise database service X 291 for customer X 281, enterprise database service Y 292 for customer Y 282, and enterprise database service Z 293 for customer Z 283.

Accordingly, the infrastructure of FIG. 2 allows small businesses to enjoy enterprise application services without needing to install and maintain a large enterprise application. Customers can access, and pay for, only portions of the enterprise application 250. For example, the customers X 281 and Y 282 send and receive data to and from all of the computer resources 210, thereby accessing the entire enterprise application 250 and all the enterprise modules, while customer Z 283 sends and receives data to and from only the enterprise module C 253, thereby accessing only enterprise application module C 253.

Enterprise Module Assembly of Enterprise Application Services

A customer that prioritizes having the enterprise application 150 on the customer's premises may purchase the “one-size-fits-all” enterprise application 150 of FIG. 1. Further, a customer that prioritizes maintaining low costs, e.g., a small business, may purchase individual modules of the enterprise application 250 of FIG. 2 to obtain limited enterprise application services at a lower cost than purchasing the entire “one-size-fits-all” enterprise application 150.

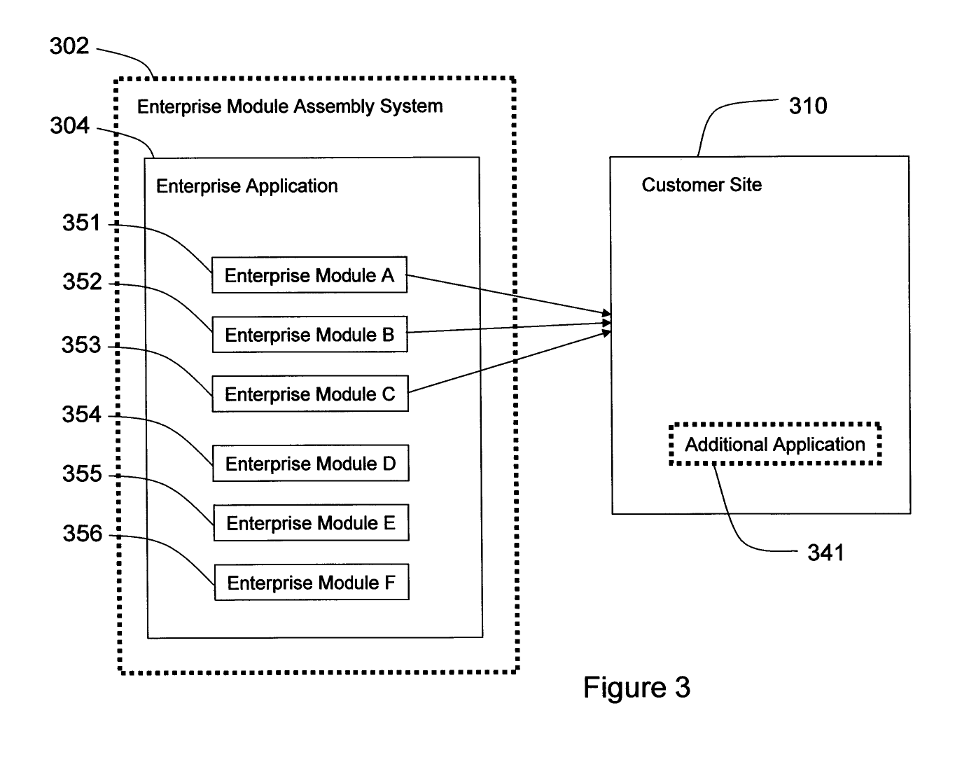

FIG. 3 illustrates an enterprise module assembly system 302 that allows a customer to both host the enterprise application software locally and only purchase the particular modules corresponding to the services that the customer actually needs. In addition, the enterprise module assembly system 302 allows a customer to integrate existing and/or new software on the customer's system with the enterprise modules that are purchased. Accordingly, the customer can assemble enterprise modules for particular services of an enterprise application in combination with the existing and/or new software on the customer's system.

In one embodiment, the enterprise module assembly system 302 breaks up an enterprise application 304 into individual enterprise modules. The enterprise application 304 can be a large complex computer application, e.g. an enterprise application or an even larger complex application program. The customer can then select the individual enterprise modules that the customer would like to utilize. Each of the enterprise modules can provide a different service. For instance, the enterprise application 304 may provide an enterprise module A 351 for purchasing source materials, an enterprise module B 352 for tracking production, an enterprise module C 353 for monitoring inventory levels, an enterprise module D 354 for monitoring quality, an enterprise module E 355 for setting pricing, and an enterprise module F 356 for maintaining customer relationships. The customer may then select which of these enterprise modules it would like to purchase. For instance, in FIG. 3, the customer has selected the enterprise module A, the enterprise module B, and the enterprise module C, but has not selected the enterprise module D, the enterprise module E, or the enterprise module F. The customer may not have selected the enterprise module D because the customer may already have existing software for monitoring quality. Further, the customer may not have selected the enterprise module E because, in the context of its business, the customer does not need any software for setting pricing. Finally, the customer may not have selected the enterprise module F because the customer plans on internally developing an additional application 341 for maintaining customer relationships.

The enterprise modules can be provided to the customer in a variety of ways. For instance, technicians can physically install the enterprise modules, which the customer has selected, at the customer site 310. Alternatively, the enterprise modules can be transmitted through a network, such as the Internet, to the customer site 310.

In another embodiment, the enterprise module assembly system 302 creates the enterprise modules as opposed to breaking up an existing enterprise application 304. In other words, the enterprise module assembly system 302 can create a collection of enterprise modules, each corresponding to a particular service, and allow a customer to select the enterprise modules that it would like to utilize.

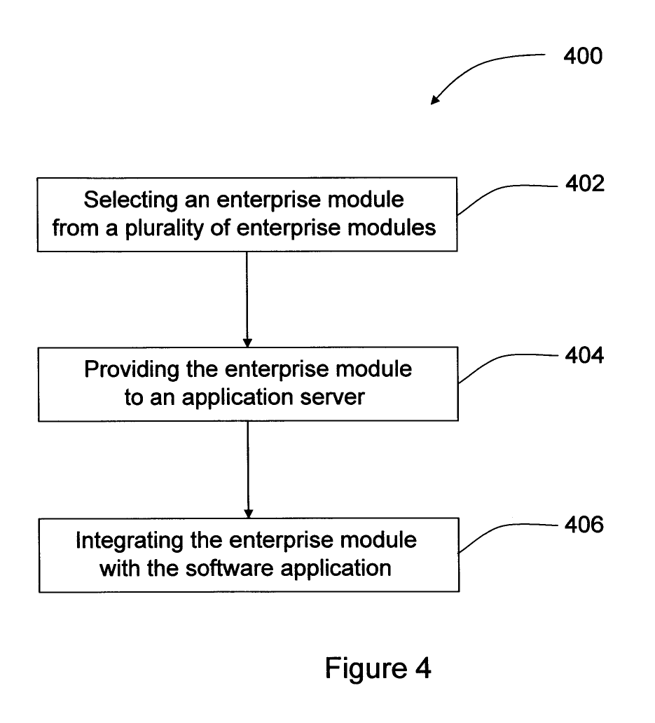

FIG. 4 illustrates a process 400 of enhancing a computer system. At a process block 402, the process 400 selects an enterprise module from a plurality of enterprise modules. The plurality of enterprise modules compose an enterprise application. Further, each of the enterprise modules includes enterprise object code generated from platform dependent source code and at least a subset of a plurality of platform dependent artifacts. As will be explained below, a developer can utilize the following to compose one of the enterprise modules: (1) high-level abstract languages to automatically generate platform dependent artifacts and (2) platform independent source code. The developer can essentially proceed with development in a portable manner because the developer can utilize a certain set of high-level abstract languages and platform independent source code irrespective of the customer's native software and hardware environment. Further, the enterprise module is developed according to an open standard because the enterprise object code is platform dependent to the specific customer's native software and hardware environment. At a process block 404, the enterprise module is provided to an application server. The application server stores a software application, which is generated from platform dependent object code. In addition, at a process block 406, the enterprise module is integrated with the software application.

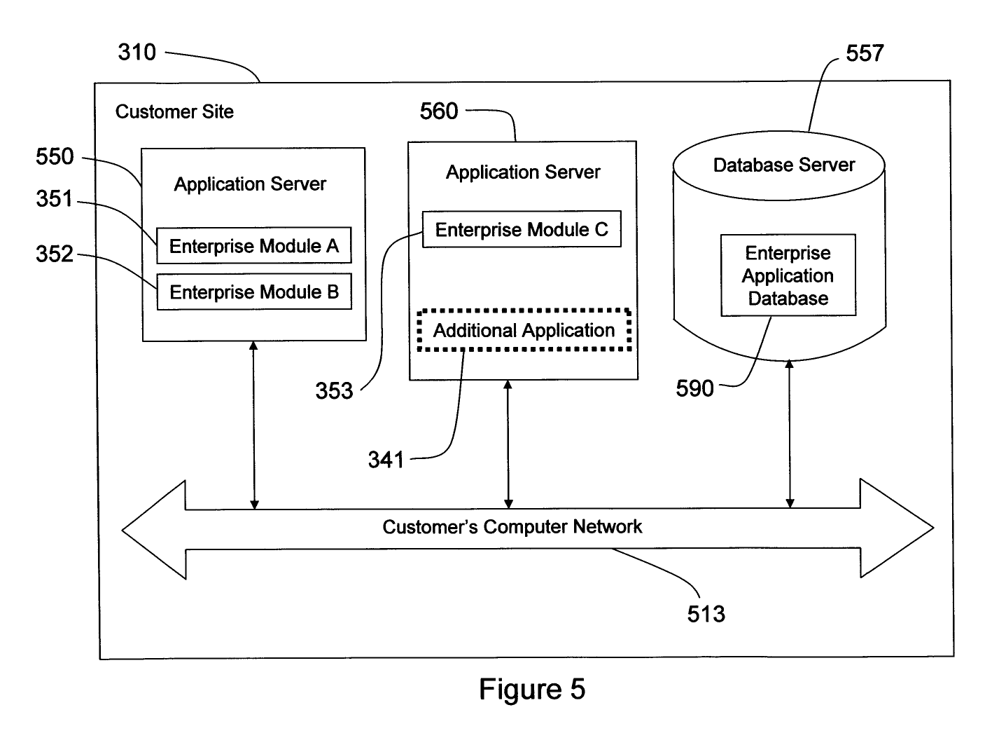

FIG. 5 illustrates an expanded view of the customer site 310, as seen in FIG. 3, for which the customer can implement the selected enterprise modules. For example, as seen in FIG. 3, the customer selects the enterprise module A, the enterprise module B, and the enterprise module C, but not the enterprise module D, the enterprise module E, or the enterprise module F. The customer may implement the selected enterprise modules on application servers, as illustrated in FIG. 5. For instance, the customer can host the enterprise module A 351 and the enterprise module B 352 on an application server 550. The application server 550 can then provide the services offered by the enterprise module A 351 and the enterprise module B 352. Further, the customer can host the enterprise module C 353 on a different application server 560. The other application server 560 may also host the additional application 341 that the customer internally developed, purchased, etc. In one embodiment, the additional application 341 includes platform dependent object code that is specific to the software and hardware at the customer site 310. While a developer composing the enterprise module C 353 was able to utilize high-level abstract languages and platform independent source code to prepare the code for the enterprise module C 353, the packaged enterprise module C 353 includes enterprise object code that is platform dependent specific to the software and hardware at the customer site 310. Since the enterprise module C 353 and the additional application 341 both include platform dependent object code compatible with the same platform, the enterprise module C 353 and the additional application 341 can be easily integrated with one another.

In addition, the customer site 310 has an enterprise application database 590 that is hosted on a database server 557. The enterprise application database 557 can store information related to each of the enterprise modules and the additional application 341 so that particular enterprise modules and/or the additional application 341 can be searched for. In addition, the customer site 310 has a computer network 513 through which the enterprise module A 351, the enterprise module B 352, the enterprise module C 353, the additional application 341, and the enterprise application database service 590 can all communicate with one another. For instance, although the enterprise module A 351 is stored on a different server than the additional application 341, the enterprise module A 351 and the additional application 341 can still communicate with one another.

Accordingly, a customer can utilize some or all of the individual enterprise modules from the enterprise application 304 (FIG. 3). The customer site 310, as illustrated in FIG. 5, can provide an open standards platform that has many tools and services for application development, application integration, and application management. Thus, a customer can easily create new application programs, e.g., the additional application 341, integrate the new application programs with the enterprise modules, and manage the enterprise modules and the new applications.

Composition of an Enterprise Module

A discussion shall now be provided regarding how an enterprise module is generated. For ease of discussion, the enterprise module A 351, as seen in FIG. 3, shall be utilized as an example of an enterprise module.

The enterprise module A 351 is constructed so that it (1) is portable and (2) utilizes an open standards platform. By being portable, the code utilized to create the enterprise module A 351 can compile and run on more than one application platform. For ease of discussion, examples shall be provided herein that utilize J2EE and .Net, which are well known platforms to one of ordinary skill in the art. However, other platforms known to one of ordinary skill in the art can easily be utilized. By being open, as discussed above, the enterprise object code included in the enterprise module A 351 is platform dependent so that the enterprise module A 351 can be easily integrated with other applications, e.g. the additional application 341 (FIG. 3), that have object code for the same platform that the customer utilizes.

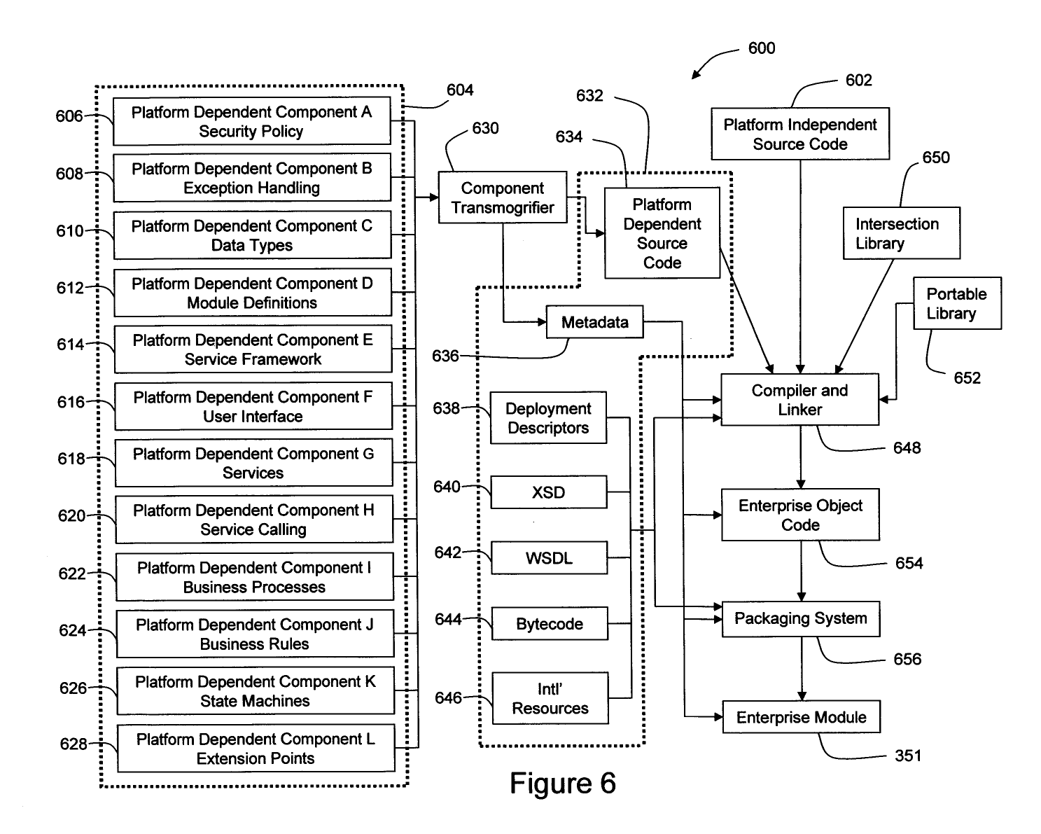

FIG. 6 illustrates an enterprise module construction system 600. The enterprise module construction system 600 can be utilized to construct the enterprise module A 351. The enterprise module A 351 is essentially constructed by combining platform independent source code 602 and a plurality of platform dependent components 604.

Initially, a developer determines what components of the enterprise module are platform independent and what components are platform dependent. In other words, in order for the enterprise module to eventually become native to a customer's system, some components of the enterprise module will require data specific to the individual customer's platform while other components of the enterprise module will not require data specific to the individual customer's platform.

The main algorithms utilized by the enterprise module A 351 are mostly not specific to the actual platform on which the enterprise module A 351 is being implemented. Accordingly, a large portion of these algorithms can be coded in platform independent source code 602. The platform independent source code 602 can be a subset of the syntax language of one or more platform independent languages. Accordingly, the platform independent source code 602 can be compiled on any of the compilers that support one of the platform independent languages utilized for the subsets. For instance, the platform independent source code 602 can be a subset of the syntax language for .Net and J2EE. If the function for concatenate is “concat” in both .Net and J2EE, then the subset includes the function “concat”. If the compiler supports Net, then the use of the function “concat” is accepted by the compiler. Similarly, if the compiler supports J2EE, then the use of the function “concat” is also accepted by the compiler. An example of a subset of syntax language is a subset of the Java 1.1.4 computer language. The subset can be compiled on either a .Net or J2EE compiler.

However, some services are platform specific. For instance, the security policy for the enterprise module A 351 may vary significantly from one platform to another. The high-level abstract languages provide the developer with a way of coding the plurality of platform dependent components 604 in a portable manner. In other words, the developer does not have to actually code each of the platform dependent components 604 according to the individual customer's native platform. The developer can utilize the same high-level abstract language to code a particular platform dependent component 604 for different customers with different native platforms.

FIG. 6 illustrates platform dependent component A 606 for Security Policy, platform dependent component B 608 for Exception Handling, platform dependent component C 610 for Data Types, platform dependent component D 612 for Module Definitions, platform dependent component E 614 for Service Framework, platform dependent component F 616 for User Interface, platform dependent component G 618 for Services, platform dependent component H 620 for Service Calling, platform dependent component I 622 for Business Processes, platform dependent component J 624 for Business Rules, platform dependent component K 626 for State Machines, and platform dependent component L 628 for Extension Points. These are merely examples of different platform dependent components. A subset of the platform dependent components illustrated, a combination of the platform dependent components illustrated, or completely different platform dependent components may be utilized.

An example of a developer utilizing high-level abstract languages would involve the developer utilizing XML to code the platform dependent component A 606 for Security Policy and Java [Any other possible example language?] to code the platform dependent component B 608 for Exception Handling. In other words, the security policy on different customer systems may be significantly different, but the developer can utilize XML to code the platform dependent component A 606 for Security Policy customers with different platforms. Further, the developer can utilize Java to code the platform dependent component B 608 for Exception Handling for different customers. While a different high-level abstract language could potentially be utilized to code each platform dependent component 604, one high-level abstract language could also be used for all of the platform dependent components 604. In addition, a set of high-level abstract languages can be utilized so that each high-level abstract language may be utilized to code more than one of the platform dependent components 604. For example, XML and Java can be utilized for the plurality of platform dependent components 604 so that half of the platform dependent components 604 are coded in XML and half of the platform dependent components 604 are coded in Java. In an alternative embodiment, some of the platform dependent components illustrated in FIG. 6 may not be native to an individual customer's platform, and the developer may choose to classify those components as platform independent components.

The enterprise module construction system 600 provides the platform dependent components 604, coded in the high-level abstract language, to a component transmogrifier 630. Further, the component transmogrifier 630 has data regarding the platform specifics of the particular customer for which the enterprise module A 351 is being developed. Accordingly, the component transmogrifier 630 can automatically convert the code written by the developer for the platform dependent components 604 into platform dependent source code 634. In other words, the developer can utilize the same high-level abstract language to generate platform dependent source code for different platforms. The developer does not have to waste the resources that would be needed to become familiar with the computer languages utilized for each customer's platform.

The component transmogrifier 630 can output a plurality of platform dependent artifacts 632. For example, the platform dependent source code 634 is a platform dependent artifact. Metadata 636 is also an example of a platform dependent artifact. The metadata 636 can be any data associated with the enterprise module A 351. For instance, the metadata 636 can provide information for a graphical user interface, such as field names. Other examples of platform dependent artifacts 632 are deployment descriptors 638, XML Schema Definition 640 (“XSD”), Web Services Description Language 642 (“WSDL”), Bytecode 644, and International resources 646. The International resources include mainly localizable artifacts, such as localized strings, dialogs, screens, etc.

Further, the plurality of platform dependent artifacts 632, such as the platform dependent source code 634, are provided to the compiler and linker 648 so that the platform dependent source code 634 can be compiled and linked with the platform independent source code 602. As a result, enterprise object code 654 is generated.

In order to help facilitate software development, the module construction system 600 provides libraries of pre-constructed code that the developer can utilize when programming in the native platform computer languages. As the module construction system 600 is portable, a developer can access pre-constructed routines for any of the native platform computer languages that are utilized. Further, an intersection library 650 includes the set of routines that is commonly available in each of the native platform computer language libraries. An intersection occurs when the same name of a function appears through each of the native computer language libraries that are being utilized. For instance, a function to change the orientation of an object may be called “reorient” in both C# and Java. Even though the underlying code for the function “reorient” may be different in C# than in Java, a compiler that supports either C# or Java can be utilized to change the orientation of the object. However, if the name of the function in C# is “reorient” and the name of the function in Java is “rotate,” the two functions may be found in the portable library 652. Further, if there is a function in C# called “reorient,” but no function in Java, then a function is composed in Java and placed in the portable library 652. In one embodiment, the newly written function has the same name as the corresponding function in C#. In an alternative embodiment, the newly written function has a different name than the corresponding function in C#. The intersection library 650 and the portable library 652 are provided to the compiler and linker 648 so that the routines that are called from the developer's code can be found during the compilation and linkage phase.

The enterprise object code 654 is platform specific so that the enterprise object code 654 can be run on the customer's computer network 513 (FIG. 5). Further, as illustrated in FIG. 6, the enterprise object code 654 is provided to a packaging system 652, which adds additional information to the enterprise object code 654 to generate the enterprise module A 351. Accordingly, the enterprise module A 351 can now be utilized for the specific platform at the customer site 310 and can also be seamlessly integrated with other software at the customer site 310.

Some of the platform dependent artifacts 632 are provided after the compiling and linking phase. For instance, metadata may be provided to the compiler and linker 648, the enterprise object code 654, and the packaging system 656. The metadata can include information specific to the customer's platform. Accordingly, the metadata can help compile, link, and package the code for the enterprise module A 351 so that the enterprise module A 351 can run on the customer's native platform. Further, the metadata can be provided to the enterprise module A 351 at run time so that the enterprise module A 351 can execute according to customer specific information.

In addition, the deployment descriptors 638, XSD 640, WSDL 642, Bytecode 644, and Intl' resources 646 can also be added to the enterprise object code 654 and to the packaging system 656. These additional platform dependent artifacts may provide additional information and/or code that assists the enterprise module A 351.

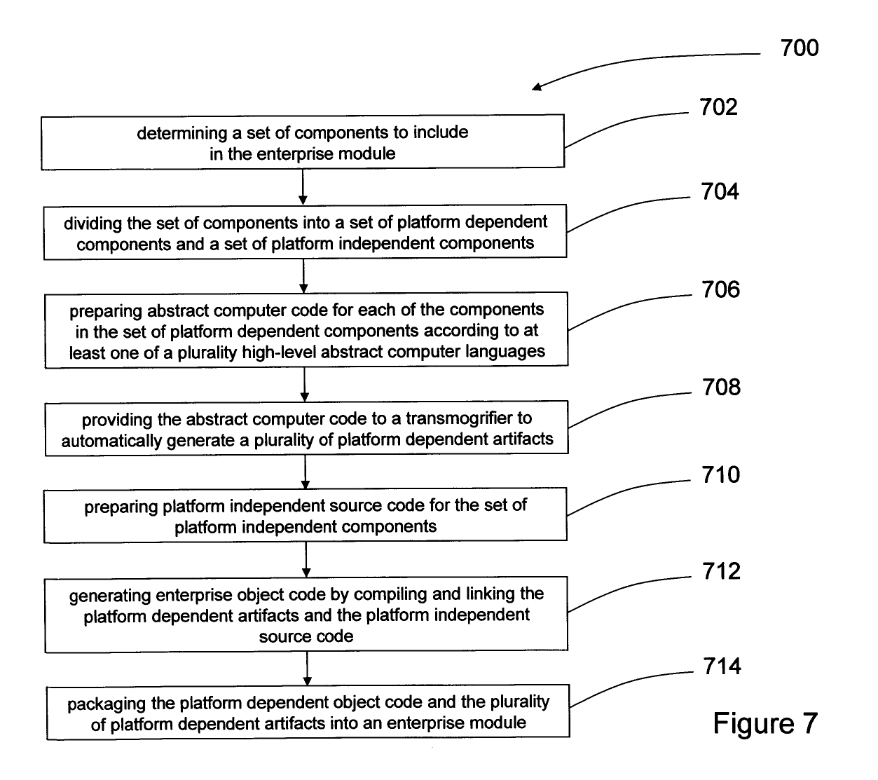

FIG. 7 illustrates a process 700 in which the enterprise module A 351 can be generated. At a process block 702, a set of components to be included in the enterprise module A 351 is determined. Further, at a process block 704, the set of components is divided into a set of platform dependent components and a set of platform independent components. In addition, at a process block 706, abstract computer code is prepared for each of the components in the set of platform dependent components according to at least one of a plurality of high-level abstract computer languages. At a process block 708, the abstract computer code is provided to a transmogrifier to automatically generate a plurality of platform dependent artifacts. The plurality of platform dependent artifacts can include platform dependent source code, metadata, deployment descriptors, XSD, WSDL, Bytecode, and Intl' resources. Further, at a process block 710, platform independent source code is prepared for the set of platform independent components. In addition, at a process block 712, enterprise object code is generated by compiling and linking the platform independent source code and at least a subset of a plurality of platform dependent artifacts. For instance, the subset of the plurality of platform dependent artifacts can include the platform dependent source code. Finally, at a process block 714, the platform dependent object code and the plurality of platform dependent artifacts are packaged into an enterprise module.

Enterprise Module Dependencies

The discussion above explains how an individual enterprise module A 351 is generated so that the enterprise module can be easily integrated with the additional application 341 at the customer's site 310, as seen in FIG. 3. In one embodiment, the enterprise module A 351 can work in concert with the other enterprise modules to optimize efficiency. Accordingly, dependency relationships can be established between the enterprise modules.

As seen in FIG. 6, the intersection library 650 and the portable library 652 provide pre-constructed code that can be utilized for the enterprise module A 351. Further, the intersection library 650 and the portable library 652 can provide routines for either or both of the plurality of the platform dependent artifacts 632 and the platform independent source code 602. In one embodiment, all of the pre-constructed code that is utilized by the enterprise module A 351 does not have to be stored in the libraries for the enterprise module A 351. For instance, if the enterprise module B 352 utilizes similar pre-constructed code to the enterprise module A 351, the pre-constructed code can be stored in a library for the enterprise module B 352. The enterprise module A 351 can then access the pre-constructed code by depending on the enterprise module B 352. Accordingly, the enterprise module A 351 does not have to inefficiently repeat storage of the same pre-constructed code. Further, the pre-constructed code can be stored by the enterprise module B 352 even if the enterprise module B 352 does not actually need to utilize that pre-constructed code. For instance, if the enterprise module A 351 needs to utilize a large amount of pre-constructed code and the enterprise module B 352 only needs to utilize a small amount of pre-constructed code, the enterprise module B 352 has extra capacity and can thereby store some of the pre-constructed code that the enterprise module A needs to utilize.

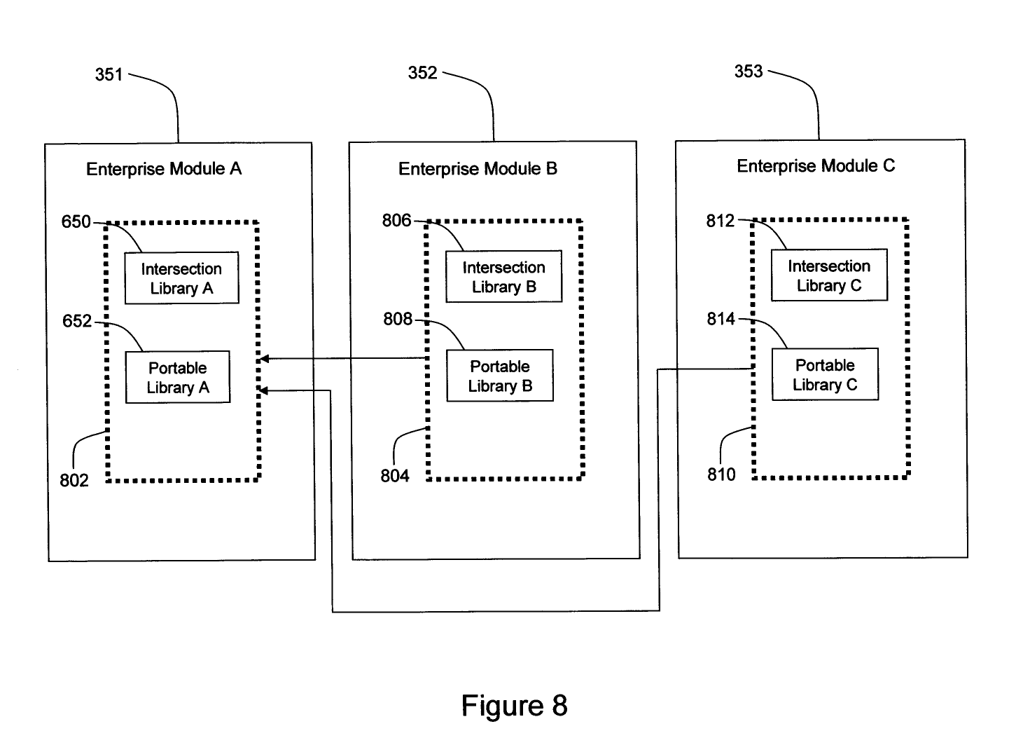

FIG. 8 illustrates enterprise module dependencies. A library collection 802 from the enterprise module A 351 depends on code form a library collection 804 from the enterprise module B 352 and a library collection 810 from the enterprise module C 353. The library collection 802 includes the intersection library A 650 and the portable library A 652. Further, the library collection 804 includes an intersection library B 806 and a portable library B 808. In addition, the library collection 810 includes an intersection library C 812 and a portable library C 814.

In the example of the pre-constructed function “reorient” discussed above, the enterprise module A 351 may wish to utilize the function “reorient,” but may not actually have the code stored in the library collection 802. Further, in order for the enterprise module A 351 to be portable, the code it utilizes has to be able to be run on multiple platforms. For instance, the code that supports “reorient” in the .Net platform may be found in the library collection 804 of the enterprise module B 352 while the code that supports “reorient” in the J2EE platform may be found in the library collection 810 of the enterprise module C 353.

As will be discussed further, the code in the enterprise module A 351 may include libraries and/or executables. In one embodiment, a dependency declaration is provided at the level of the library or executable. Tags can be used to indicate the dependencies. For instance, a “<platformDepend>” tag can be utilized to indicate a dependency relationship. In the context of FIG. 8, the following code is provided as an example to illustrate the dependency of the portable library A 652 of the enterprise module A 351 to the portable library 808 of the enterprise module B 352 and the portable library 814 of the enterprise module C 353.

```
<libraries>
    <library name=”portablelibraryA”>
      <platform name=”java” >
        <platformDepend module=”B” component=”library”
        name=”portablelibraryB” />
        <code language=”java” includes=”**/*.java” />
      </platform>
      <platform name=”dotnet”>
        <platformDepend module=”C” component=”library”
        name=”portablelibraryC” />
        <code language=”java” includes=”**/*.java” />
      </platform>
    </library>
```

When the portable library A 652 of the enterprise module A 351 is compiled on a Java platform, the portable library A 652 will have a dependency to the portable library B 804 of the enterprise module B 352. On the other hand, when the portable library A 652 of the enterprise module A 351 is compiled on a .Net platform, the portable library A 652 will have a dependency to the portable library C 814 of the enterprise module C 353.

In another embodiment, the portable library A 652 of the enterprise module A 351 may be able to rely on at least a portion of its own code, thereby allowing the portable library A 652 to rely less, or possibly not at all, on the portable library B 808 of the enterprise module B 352 and the portable library C 814 of the enterprise module C 353. Accordingly, an analysis is performed to determine what dependencies are needed or whether any dependencies are needed at all.

A portability tree can be constructed to determine what code is portable and what code is non-portable. Routines for the portable code can be placed in the platform independent source code 602 while routines for the non-portable code can be placed in the portable library 652. Since a subset of platform independent languages is utilized for the platform independent code, only one routine for a particular task is placed into the platform independent source code 602. On the other hand, multiple routines for the same task may need to be placed into the portable library 652 to ensure that the same task can be performed by platform dependent code on any of the intended platforms at the customer site 310, as seen in FIG. 3.

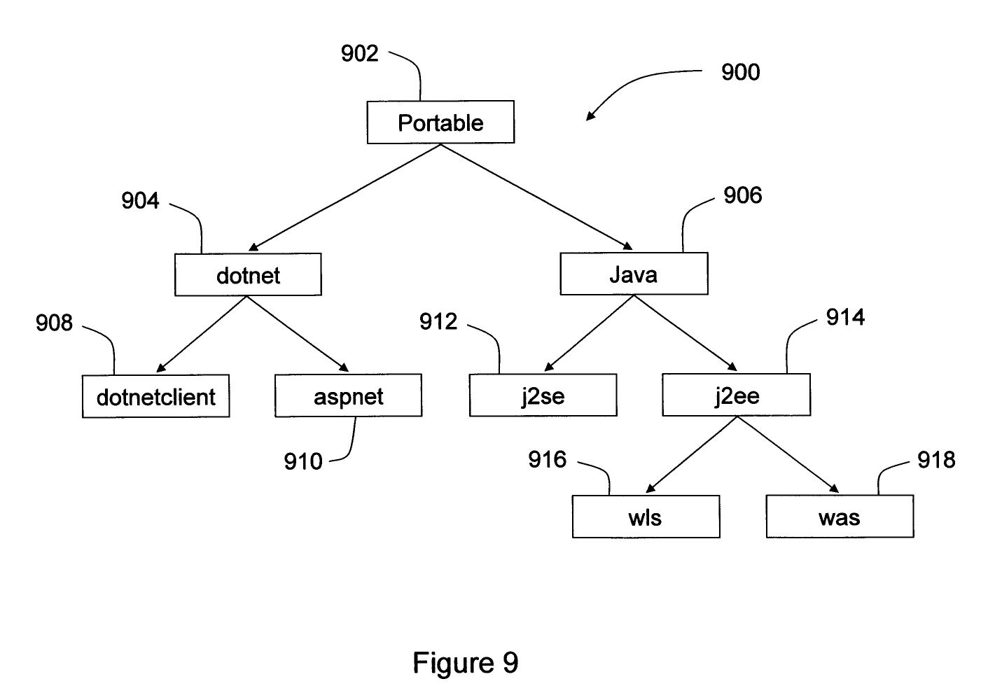

FIG. 9 illustrates a portability tree 900 that can be utilized to classify a set of code as portable and another set of code as non-portable. The portability tree 900, as seen in FIG. 9, depicts an example of a plurality of platforms and the relative level of portability for each of those platforms. A portable region 920 of the portability tree 900 indicates code that can run on a portable platform, thereby being platform independent. Further, a non-portable region 922 of the portability tree 900 indicates code that needs to run on a non-portable platform, thereby being capable of being compiled with code from the portable library 652. The leaflets of the portability tree 900 are placeholders for code in actual platforms where as any of the nodes above the leaflets are placeholders for code in virtual platforms. Through a downward propagation of the portability tree 800, the virtual platforms map to leaflets that hold code for actual platforms.

The root of the portability tree 900 is the most portable virtual platform where as the leaflets are the most specific and non-portable. For instance, if the code included in the enterprise module A 351 is written according to a portable node 902, the code can be utilized on any of the intended actual platforms for which the leaflets store code. At the next level of the portability tree 900, the code in the enterprise module A 351 is written in code for either the .Net 904 node or the Java node 906. If the code is written for the .Net 904 node, then the code may not be compatible with the Java node 906, and vice versa. At the next level of the portability tree 900, the code in the enterprise module A 351 is written for the dotnet client node 908, the aspnet node 910, the j2se node 912, or the j2ee node 914. Code written in the dotnet client node 908 or the aspnet node 910 is compatible with the .Net node 904. Further, code written in the j2se node 912 or j2ee node 914 is compatible with Java 906. At the next level of the portability tree 900, the code in the enterprise module A 351 is written for the wls node 916 or the was node 918. Further, code written for the wls node 916 or the was node 918 is compatible with j2ee node 914. One of ordinary skill in the art will be familiar with these different platforms. Accordingly, the portability tree 900 can be utilized to classify the different pieces of code in the enterprise module A 351.

For instance, after performing a portability tree 900 analysis on the code of the enterprise module A 351, it may be determined that the enterprise module A 351 has a library and/or executable with code written and/or generated at the portable node 902, code written and/or generated for .Net 904, and code written and/or generated for the was node 918. With respect to the code for the portable node 902, the enterprise module A 351 can run this code on any platform. During a build, code can be generated for each of the platforms in the leaflet nodes. Accordingly, a downward propagation can be performed to build code for each of the platforms at a lower level. A downward propagation is intended to mean a traverse down to the leaflets of a position in the portability tree 900.

With respect to the code for .Net node 904, the enterprise module A 351 can run this code on any .Net platform. Further, a downward propagation can be utilized to generate code on any of the platforms that are leaflets from the .Net node 904, e.g., the dotnet client node 908 and the aspnet node 910. However, this code cannot be run on any of the leaflet nodes of the Java node 906, e.g., the j2se node 912 or the j2ee node 914, or any of the leaflets from the j2ee node 914, e.g., the wls node 916 or the was node 918. The code at the leaflet nodes needs to be compiled with the intersection library 650 and the portable library 652 to ensure that the platform specific routines needed by the platform dependent code is available.

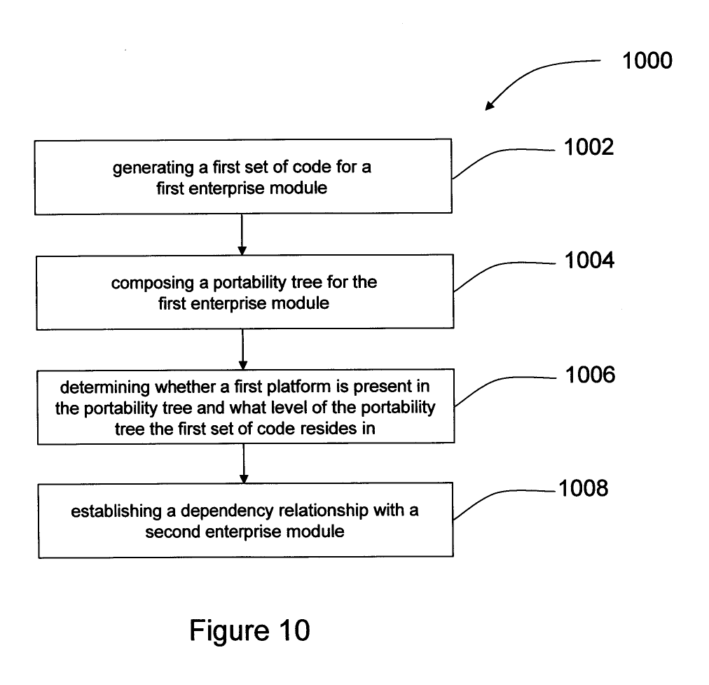

FIG. 10 illustrates the intersection library 650. Native platform library A 1002 has a first set of pre-constructed code that is included within the bounded area of platform independent library A 1002. Further, native platform library B 1004 has a second set of pre-constructed code that is included within the bounded area of platform independent library B 1004. The intersection library 650 includes the intersection of function signatures, e.g., method names and arguments, from the native platform library A 1002 and the native platform library B 1004.

FIG. 10 illustrates a process 1000 for creating a portable enterprise module. At a process block 1002, the process 1000 generates a first set of code for a first enterprise module. The first set of code is designed to run on a first platform. At a next process block 1004, the process 1000 composes a portability tree for the first enterprise module. The portability tree includes a plurality of levels. The plurality of levels include a root level, a first sub-level, and a second sub-level. The root level includes a portable platform. Further, the first sub-level includes a plurality of first sub-level non-portable platforms. In addition, the second sub-level includes a plurality of second sub-level non-portable platforms. At a next process block 1006, the process 1000 determines whether the first platform is present in the portability tree and what level of the portability tree the first set of code resides in. Finally, at a process block 1008, the process 1000 establishes a dependency relationship with a second enterprise module, distinct from the first enterprise module, if the platform resides in the first sub-level or the second sub-level.

The portability tree 900, as seen in FIG. 9, is not limited in the number of levels that the portability tree 900 can utilize. In other words, the portability tree 900 can have many sub-levels. Further, any of the sub-levels can be utilized as the first sub-level or the second sub-level, as long as the root level is not utilized and the second sub-level is below the first sub-level. For instance, the first sub-level does not necessarily have to be the level below the root level. Further, the second sub-level does not have to be the last level. In addition, there can be levels in between the first sub-level and the second sub-level. Accordingly, a platform on the first sub-level is compatible with a platform on the second sub-level, thereby allowing for downward propagation. However, it is not necessarily the case that a platform on the second sub-level is compatible with a platform on the first sub-level, thereby preventing upward propagation. Therefore, supplementation is needed for the platforms included in the upward propagation. Further, supplementation is needed for the platforms in between the first sub-level platform and the second sub-level platform.

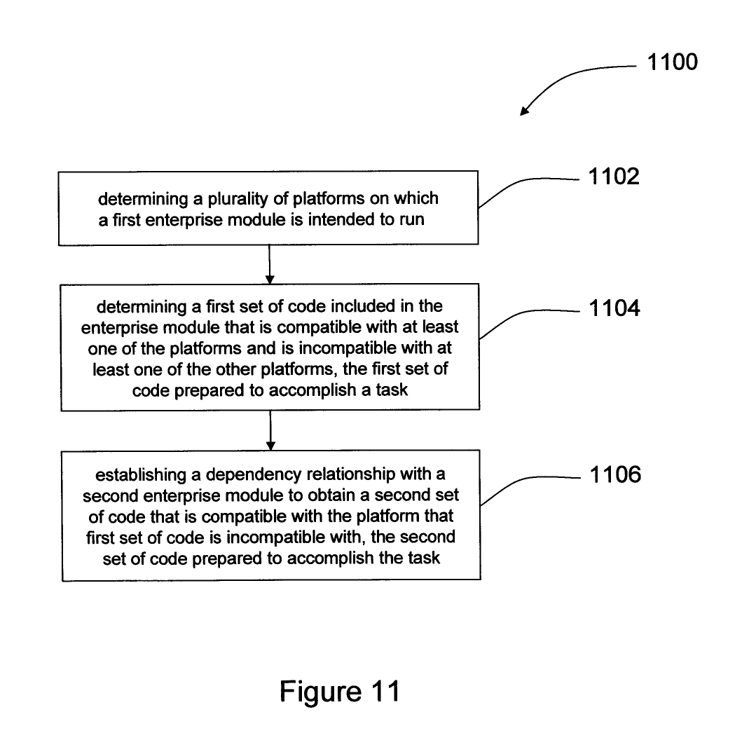

In one embodiment, dependency relationships can be established without utilizing the portability tree 900. FIG. 11 illustrates a process 1100 of generating a portable enterprise module. At a process block 1102, the process 1100 determines a plurality of platforms on which a first enterprise module is intended to run. Further, at a process block 1104, the process 1100 determines a first set of code included in the enterprise module that is compatible with at least one of the platforms and is incompatible with at least one of the other platforms. The first set of code is prepared to accomplish a task. In addition, at a process block 1106, the process 1100 establishes a dependency relationship with a second enterprise module to obtain a second set of code that is compatible with the platform that first set of code is incompatible with. The second set of code is prepared to accomplish the task.

In order to help facilitate the type of platform that a particular library is associated with, a declaration can be provided for each executable and/or library to indicate the type of platform that the executable and/or library can run on. Accordingly, an analysis to determine the need for dependency relationships can be performed on the platform declaration of the code in the enterprise module A 351 to determine what platforms are present and what platforms are missing. Further, an analysis can be performed on the platform declarations of the code in the other enterprise modules to determine if other enterprise modules have code for the missing platform, thereby facilitating the identification of enterprise modules to which dependency relationships can be created. In one embodiment, a declaration file can be written to describe the enterprise module. Accordingly, the declaration file can be placed into the subdirectory for the enterprise module. The declaration file can begin with a <libraries> tag to indicate which library is being referred to, e.g., the intersection library 650 or the portable library 652. Further, a <platform name> tag can be provided to indicate what platform the library supports. In addition, a <code language> tag can be utilized to tell the system what computer language to utilize to build the source files. The following code is illustrative of a declaration file:

```
<libraries>
  <library name=”PortableLibraryA”>
    <platform name=”java” supported=”false” />
    <platform name=”dotnet”>
      <code language=”java” includes=”**/*.java” />
    </platform>
  </library>
  <library name=”IntersectionLibraryA”>
    <platform name=”dotnet” supported=”false” />
    <platform name=”java”>
      <code language=”java” includes=”**/*.java” />
    </platform>
  </library>
</libraries>
```

As an example, with respect to the Portable Library A, the code above indicates that the build system is to look under the “dotnet” subdirectory and search for all the files with the “.java extension. An “excludes” attribute can be utilized to exclude certain files. For example, the following code will find all of the .java files except for bad.java: <code language=“java” includes=“**/*.java” excludes=“**/bad.java”/>. Further, multiple types of platforms can be designated. For instance, the following code utilizes multiple masks: <code language=“java” includes=“**/*.java,**/*.jsl”/>. Accordingly, the build system will find all the files with the .java and .jsl extensions. In addition, a tag can indicate what platforms are not supported. For instance, the following code provided in the above example indicates that Portable Library A should not be built on a java platform: <platform name=“java” supported=“false”/>.

In one embodiment, a code propagation policy can ensure that if a declared platform is unsupported, all of its descendents are also unsupported. In another embodiment, this aspect of the code propagation policy can be overwritten by specifically declaring the descendent platform.

In another embodiment, dependency relationships are created to avoid circular dependency relationships. In other words, a first enterprise module does not have a dependency relationship, direct or indirect, to a second enterprise module that has a dependency relationship, direct or indirect, to the first enterprise module. A circular dependency relationship can potentially lead to a situation in which two enterprise modules are depending on one another for code without either of the enterprise modules actually having the code.

By establishing dependency relationships at the enterprise module level, the complexity of maintaining the dependency relationships is significantly reduced. In other words, the dependency relationships do not have to be tracked at the file level or at the library level. For instance, when packaging an enterprise module, the other enterprise modules from which it depends can be easily deduced by performing a recursive walk through the dependency declarations of each enterprise module. As a result, a list of dependency relationships can be compiled.

In yet another embodiment, an enterprise module can include a library, executable, repository, and/or a module interface. The library can include a collection of classes working together. Further, the executable provides an entry point for execution. In addition, the repository provides a collection of configuration files. For instance, the repository can contain XML files describing object types and object definitions. A dependency relationship between repositories of two enterprise modules essentially creates a dependency relationship between the two enterprise modules. Further, the module interface exposes a set of interfaces that can be utilized by other enterprise modules.

Examples are now provided for different module interfaces. The module interfaces can include strings, exceptions, XSD-based types, web service proxy, web service skeleton, and configuration. Further, these different module interfaces can include generated code. Strings are classes that help manage string resources. Further, Exceptions are classes generated based on an exception message and group which a particular exception belongs to. In addition, XSD-based types are classes or types described by XML Schema. The XSD-based types provide the ability to serialize to streams and files. Further, the XSD-based types allows the association of the generated type to a subclass instead of the basic generated class skeleton. As a result, the developer can permanently augment a generated base class without losing added functionality each time a class is regenerated. In addition, a Web service proxy is a strongly typed proxy class for accessing a web service. The generated proxy classes are portable so that they can be utilized for all of the intended platforms. Accordingly, separate versions of the proxy are not needed for the different platforms. Further, a web service skeleton class provides the infrastructure needed for a web service. In addition, a configuration type provides a framework to work with a set of name-value pairs of configuration information.

In one embodiment, the code for an enterprise module can be provided in a subdirectory. For instance, the code in a system can be partitioned into code for applications, build system, core, and other categories. Further, each of these subdirectories can have more partitions that can be utilized to logically group and organize the code base. Accordingly, a subdirectory can be allocated for the enterprise module. The subdirectory can be identified by the presence of a module declaration file that defines the contents of the enterprise module and declares the relationship dependencies of the enterprise module. For instance, the module declaration file can be denoted as “module.dcl.”

Conventions can be utilized for the structure of the subdirectories under the module subdirectory. One convention may be that the enterprise module's subdirectory should have the same name as the enterprise module's name. For instance, the enterprise module build-system may have a subdirectory build-system in which the module.dcl file is located. Another convention can be that, for each library and executable in the enterprise module, a subdirectory is created under the enterprise module directory with the same name as that of the library or executable. For instance, the library buildgen in the build-system enterprise module may have its code stored under the subdirectory build-system\buildgen. Yet another convention can be that, under each library or executable, a subdirectory is created for each platform that holds the code for the library. For instance, the buildgen library may have code whose portability category is portable. The code for the portable platform can be stored in build-system\buildgen\portable. Another convention involves creating package subdirectories once the correct platform subdirectory is created. The package subdirectories can follow the convention utilized by Java so that each subdirectory corresponds to a part in the package name separated by the “.” character.

The actual build process for an enterprise module shall now be described. A first build file generation process has two main phases. The first phase iterates through a list of subdirectory locations and recursively scans for module.dcl files. When an instance of the module.dcl file is found, the location of the where the module.dcl file is found gets recorded as the location of the enterprise module described in the module.dcl file. The collection of these enterprise modules makes up all the enterprise modules that the build system knows about until the first build file generation process is run again. In the second phase, each module.dcl file is serialized into memory and processed further. The dependency relationships declared in each enterprise module, as well as information about the libraries and executables that will eventually be generated or built, are recorded in a properties file. Further, a collection of build.xml files can be generated. The build.xml files contain instructions to invoke the proper tools to generate, compile, and package the libraries and executables that make up an enterprise module. A module.dcl file is generated for each enterprise module in its location, alongside the module.dcl file. An additional build file can be generated at a root location. The build file at the root location is the main build file that will call the individual build files. This allows a single invocation .xml build files to build all the modules detected by the build file generation process.

A second build file generation process is code generation and compilation. If the second build file generation process is invoked at the root location, where the main build filed is generated, then the main build file simply traverses through a list of build files that make up all the enterprise modules and build each one as the main build file goes through the list. At the end of the traverse, all the enterprise modules know to the build system are built. If the second build file generation process is invoked at one of the enterprise module's locations, then that particular enterprise module and all of its dependencies are built. For example, if a module has a dependency on the infrastructure enterprise module, for example, then building the enterprise module will also built the infrastructure module. Therefore, a developer does not need to be concerned about the sequence of the build in that a prerequisite library may not have been built yet. As each enterprise module is built, all of its dependencies are built. This is based on the assumption that the enterprise module is properly declared in the module.dcl file.

The code generation will invoke a code generator to generated the source files implementing the declared items for the enterprise module. The platform that is utilized for generating the source code is determined by how the declared item is declared in the module.dcl file.

The compilation involves feeding source code through the appropriate compiler to emit binary components. The binary components can take the form of a library or an executable. The form of the binary component is declared in the module.dcl file. For example, a JAR file can be built for a Java platform while an EXE or DLL file can be built for a .Net platform.

In general, routines executed to implement the embodiments can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions can be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Some aspects can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), or firmware such as electrically erasable programmable read-only memory (EEPROM's).

In various embodiments, hardwired circuitry can be used in combination with software instructions to implement the embodiments. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent can be reordered and other operations can be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications can be made thereto without departing from the broader spirit and scope of the following claims. The specification and drawings are, accordingly, to be regarded in an illustrative sense rather than a restrictive sense.

1. A system comprising:
a unit that generates a first set of code for a first enterprise module, the first set of code designed to run on a first platform;
a unit that composes a portability tree for the first enterprise module, the portability tree including a plurality of levels, the plurality of levels including a root level, a first sub-level, and a second sub-level, the root level including a portable platform, the first sub-level including a plurality of first sub-level non-portable platforms, the second sub-level including a plurality of second sub-level non-portable platforms;
a unit that determines whether the first platform is present in the portability tree and what level of the portability tree the first set of code resides in; and
a unit that establishes a dependency relationship with a second enterprise module, distinct from the first enterprise module, if the platform resides in the first sub-level or the second sub-level.

2. The system of claim 1, wherein the portable platform is compatible with each of the first sub-level non-portable platforms.

3. The system of claim 1, wherein at least one of the first sub-level non-portable platforms is compatible with at least one of the second sub-level non-portable platforms.

4. The system of claim 1, further comprising a unit that obtains code from the second enterprise module for at least one platform on the same level at which the first platform resides.

5. The system of claim 1, further comprising a unit that obtains code from a library in the second enterprise module for at least one platform on the same level at which the first platform resides.

6. The system of claim 1, further comprising a unit that obtains code from the second enterprise module for at least one platform in the first sub-level of the portability tree if the first platform resides on the second sub-level of the portability tree.

7. The system of claim 1, further comprising obtaining code from a library in the second enterprise module for at least one platform in the first sub-level of the portability tree if the first platform resides on the second sub-level of the portability tree.

8. The system of claim 1, wherein the first set of code is included within a library within the first enterprise module.

9. The system of claim 1, wherein a platform tag is utilized in the first set of code to indicate that the first set of code is designed to run on the first platform.

10. The system of claim 1, wherein a platform tag is utilized in a second set of code in the second enterprise module to indicate a platform that the second set of code can be run on.

11. A machine readable medium having stored thereon a set of instructions which when executed perform a method comprising:
generating a first set of code and a second set of code for a first enterprise module, the first set of code supported by a first platform, the second set of code supported by a second platform, the first set of code distinct from the second set of code, the first platform distinct from the second platform;
composing a portability tree for the first enterprise module, the portability tree including a plurality of levels, the plurality of levels including a root level, a first sub-level, and a second sub-level, the root level including a portable platform, the first sub-level including a plurality of first sub-level non-portable platforms, the second sub-level including a plurality of second sub-level non-portable platforms;
determining whether the platform that the first set of code is designed to run on is present in the portability tree and what level of the portability tree the first set of code resides in;
determining whether the platform that the second set of code is designed to run on is present in the portability tree and what level of the portability tree the second set of code resides in;
establishing a dependency relationship with a second enterprise module, distinct from the first enterprise module, if the platform that the first set of code is designed to run on resides in the first sub-level or the second sub-level; and
establishing a dependency relationship with a third enterprise module, distinct from the first enterprise module and the second enterprise module, if the platform that the second set of code is designed to run on resides in the first sub-level or the second sub-level.

12. The machine readable medium of claim 11, wherein the portable platform is compatible with each of the first sub-level non-portable platforms.

13. The machine readable medium of claim 11, wherein at least one of the first sub-level non-portable platforms is compatible with at least one of the second sub-level non-portable platforms.

14. A method comprising:
determining a plurality of platforms on which a first enterprise module is intended to run;
determining a first set of code included in the first enterprise module that is compatible with at least one of the platforms and is incompatible with at least one of the other platforms, the first set of code prepared to accomplish a task; and
establishing a dependency relationship with a second enterprise module to obtain a second set of code that is compatible with the platform that first set of code is incompatible with, the second set of code prepared to accomplish the task.

15. The method of claim 14, further comprising composing a portability tree for the first enterprise module.

16. The method of claim 14, wherein a declaration file in the first enterprise module indicates the at least one of the platforms that the first set of code is compatible with.

17. The method of claim 14, wherein a declaration file in the first enterprise module indicates the at least one of the platforms that the first set of code is incompatible with.

18. The method of claim 14, wherein a declaration file in the second enterprise module indicates the second set of code is compatible with the platform that the first set of code is incompatible with.

19. The method of claim 14, wherein the plurality of platforms includes .Net.

20. The method of claim 14, wherein the plurality of platforms includes Java.
